(19) United States
(12) Patent Application Publication
(10) Pub. No.: US 2005/0184423 A1
(43) Pub. Date: Aug. 25, 2005

(54) Method for fabricating a stamper

(75) Inventors: Ga-Lane Chen, Fremont, CA (US); Tai-Cherng Yu, Tu-Cheng (TW); Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/024,532

(22) Filed: Dec. 29, 2004

(30) Foreign Application Priority Data
Feb. 20, 2004 (TW) 93104231

(51) Int. Cl. B29D 17/00; B28B 7/34

(52) U.S. Cl. 264/106; 425/810; 249/134

(57) ABSTRACT

A method of for fabricating a stamper includes the following steps: (a) providing a substrate (30); (b) coating a photo-resist layer (50) on the substrate; (c) exposing and developing the photo-resist layer to form a photo-resist pattern (52); (d) etching the substrate; and (e) removing the photo-resist pattern to thereby provide the stamper. The method of the present invention does not require an electroforming step or create an electroformed layer. The formed stamper only includes a derivative of the substrate, which is made of nickel or steel. The substrate can have a large thickness, in order that the substrate has a high rigidity. Thus, the stamper resists distortion and has a long service life.

### BACKGROUND OF THE INVENTION

1. Field of the Invention

The present invention relates to a method for fabricating a stamper, such as a stamper used for manufacturing light guide plates of liquid crystal displays.

2. Description of the Prior Art

At present, stampers are widely utilized in many kinds of production processes, such as in the manufacture of light guide plates. Conventional methods for fabricating stampers take a long time. Generally, the whole period for fabricating a stamper from start to finish is approximately one month. Although methods for fabricating stampers are being improved, they cannot keep pace with the advances being made in related production processes which are much speedier.

Taiwan patent publication No. 522263 discloses a method for fabricating a stamper. Referring to FIGS. 6 to 11, the method includes the following steps: (1) providing a conductive substrate 10; (2) coating a negative photo-resist layer 20 on the substrate 10; (3) exposing the photo-resist layer using a photo-mask to form a plurality of exposed portions 24 and unexposed portions 22; (4) developing the photo-resist layer 20 to dissolve the unexposed portions 22; (5) electroforming an electroformed layer 12 where the unexposed portions 22 are dissolved; and (6) removing the exposed portions 24 of the photo-resist layer 20, thereby providing a stamper 1. The stamper 1 comprises the substrate 10 and the electroformed layer 12, with the electroformed layer 12 being a pattern of the stamper 1.

A thickness of the electroformed layer 12 formed by the electroforming step is generally less than 2 mm, therefore the electroformed layer 12 cannot reliably endure high pressure. The electroformed layer 12 is prone to distort, and the stamper 1 generally has a short service life.

It is desired to provide an improved method for fabricating a stamper that overcomes the above-described problems.

### SUMMARY OF THE INVENTION

Accordingly, an object of the present invention is to provide a method for fabricating a stamper, whereby the stamper has a long service life.

In order to achieve the above-mentioned object, a method of the present invention for fabricating a stamper comprises the following steps: (a) providing a substrate; (b) coating a photo-resist layer on the substrate; (c) exposing and developing the photo-resist layer to form a photo-resist pattern; (d) etching the substrate; and (e) removing the photo-resist pattern to thereby provide the stamper.

In summary, the method of the present invention does not require an electroforming step. The formed stamper only includes a derivative of the substrate. The substrate can have a large thickness, in order that the stamper has a high rigidity. Thus, the stamper resists distortion and has a long service life.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a flow chart of a method for fabricating a stamper according to the present invention;

FIG. 2 is a schematic, cross-sectional view of a substrate having a photo-resist layer coated thereon, according to the method of the present invention;

FIG. 3 is similar to FIG. 2, but also showing a photo-mask used to expose the photo-resist layer, and showing a photo-resist pattern formed on the substrate by using the photo-mask;

FIG. 4 is similar to FIG. 3, but showing the substrate after an etching step has been completed;

FIG. 5 is similar to FIG. 4, but showing the substrate after the photo-resist pattern has been removed, the substrate constituting the fabricated stamper;

FIG. 6 is a schematic, cross-sectional view of a substrate used in a conventional method for fabricating a stamper;

FIG. 7 is similar to FIG. 6, but showing a photo-resist layer formed on the substrate;

FIG. 8 is similar to FIG. 7, but showing the photo-resist layer after an exposing step has been completed, whereby exposed portions and unexposed portions are formed;

FIG. 9 is similar to FIG. 8, but showing the substrate after the unexposed portions have been removed;

FIG. 10 is similar to FIG. 9, but showing an electroformed layer formed on the substrate; and

FIG. 11 is similar to FIG. 10, but showing the substrate after the exposed portions have been removed, thereby providing the fabricated stamper.

### DETAILED DESCRIPTION OF THE INVENTION

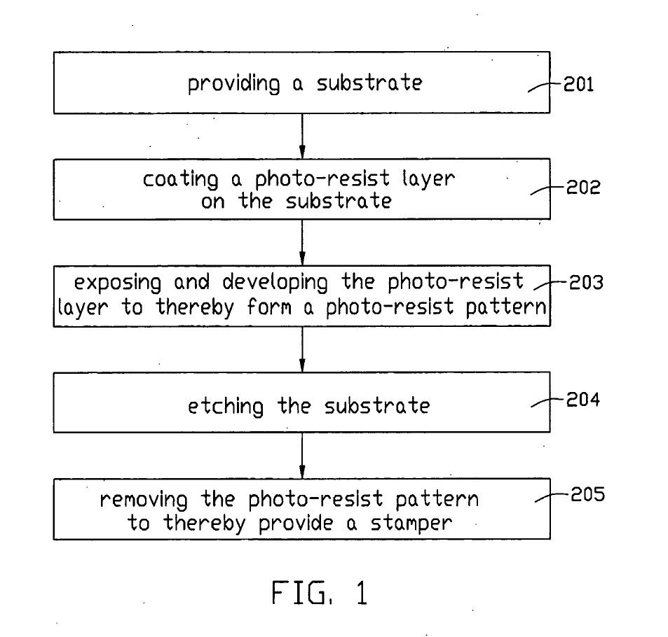

Referring to FIG. 1, a method for fabricating a stamper of the present invention includes five steps: (a) providing a substrate (step 201); (b) coating a photo-resist layer on the substrate (step 202); (c) exposing and developing the photo-resist layer using a photo-mask having a predetermined pattern to thereby form a photo-resist pattern (step 203); (d) etching the substrate (step 204); and (e) removing the photo-resist layer to thereby provide a stamper (step 205).

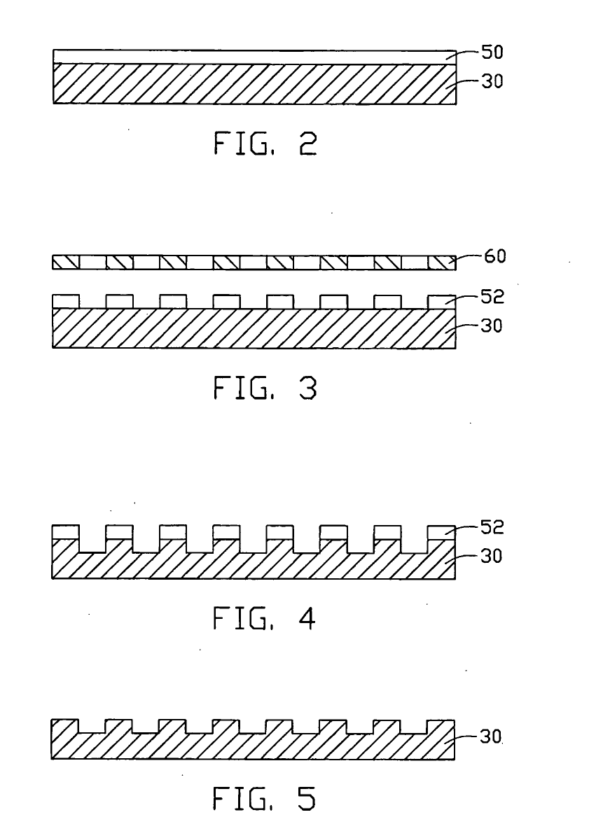

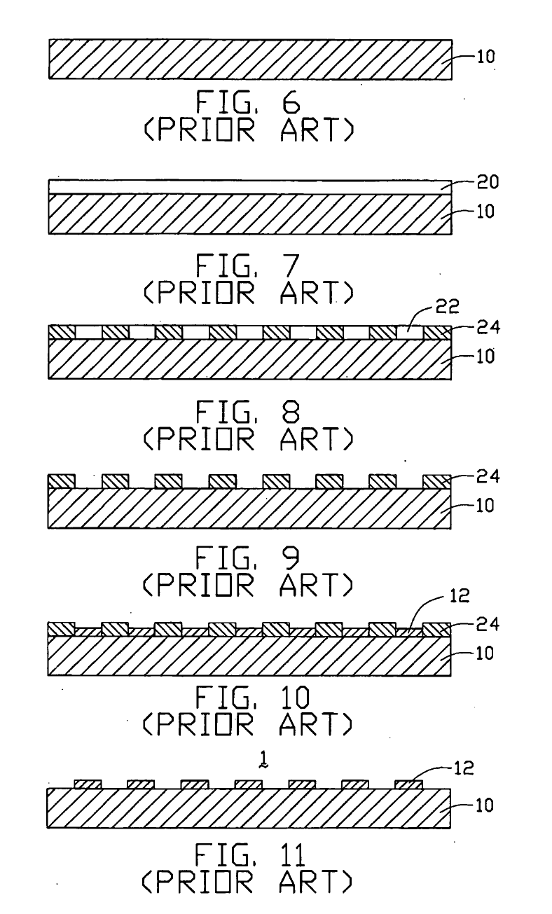

Referring to FIG. 2, in the first step, a substrate 30 is provided. The substrate 30 is a polished nickel sheet. The substrate 30 is baked in a vacuum or in a nitrogen environment at a temperature between 100° C. and 120° C. for 4˜6 minutes, in order to dehydrate the substrate 30. In the second step, a photo-resist layer 50 is coated on the substrate 30 by a spin-coating method or a spray-coating method. The photo-resist layer 50 is an organic, positive photo-resist. Then, the substrate 30 having the photo-resist layer 50 is baked at a temperature between 90° C. and 100° C. for 20˜30 minutes to enhance adhesion between the photo-resist layer 50 and the substrate 30.

Referring to FIG. 3, in the third step, the photo-resist layer 50 is exposed and developed. Ultraviolet (UV) radiation is emitted through a photo-mask 60 onto the photo-resist layer 50, the photo-mask 60 having a predetermined pattern. Exposed parts of the photo-resist layer 50 receive the UV radiation, whereby the exposed parts become easily dissolvable in a developer.

After exposure, a baking step is performed again. The substrate 30 is baked at a temperature between 100° C. and 120° C. for 20˜30 minutes, in order to make unexposed parts of the photo-resist layer 50 further resistant to being dissolved.

Then, a developer which can dissolve the exposed parts of the photo-resist is sprayed on the photo-resist layer 50. The developer can be dimethylbenzene. The substrate 30 is maintained for 30˜60 seconds in order that the exposed parts of the photo-resist layer 50 are fully dissolved. The unexposed parts of the photo-resist layer 50 remain, and cooperatively define a photo-resist pattern 52.

Referring to FIG. 4, the substrate 30 having the photo-resist pattern is etched. A dry etching step, preferred a reactive ion etching step, is performed. The substrate 30 is placed in a reaction chamber. A voltage in the range from 300˜500V is applied to the chamber. Gas ions in the chamber are driven by the voltage, and are accelerated to bombard the substrate 30 having the photo-resist pattern 52. Parts of the substrate 30 that are not covered by the photo-resist pattern 52 are etched a predetermined depth. Thereby, the pattern of the photo-mask 60 complementary to the photo-resist pattern 52 is transferred onto the substrate through the photo-resist pattern 52. A pressure of the reaction chamber is 10⁻˜10⁻³ torr. The gas ions are chloride ions, such as from carbon tetrachloride (CCl₄) or boron chloride (BCl₃).

Referring to FIG. 5, the photo-resist pattern 52 is removed. A chemical solution, which only can dissolve the photo-resist, is sprayed onto the substrate 30 having the photo-resist pattern 52. The photo-resist pattern 52 is thus dissolved and removed.

The present invention may have other embodiments as follows. The substrate 30 can be a polished steel sheet. The dry etching method can be replaced by any of various wet etching methods. The photo-resist layer 50 can be an organic, negative photo-resist. If an organic, negative photo-resist is used, a developer that can dissolve a negative photo-resist should also be used. In such case, the unexposed parts of the photo-resist layer 50 are dissolved by the developer.

In summary, the method of the present invention does not require an electroforming step or create an electroformed layer. The formed stamper only includes a derivative of the substrate 30, which is made of nickel or steel. The substrate 30 can have a large thickness, in order that the substrate 30 has a high rigidity. Thus, the stamper resists distortion and has a long service life.

It is to be understood that even though numerous characteristics and advantages of the present invention have been set out in the foregoing description, together with details of the steps and function of the invention, the disclosure is illustrative only, and changes may be made in detail, especially in matters of arrangement of steps within the principles of the invention to the full extent indicated by the broad general meaning of the terms in which the appended claims are expressed.

1. A method for fabricating a stamper, comprising:
(a) providing a substrate;
(b) coating a photo-resist layer on the substrate;
(c) exposing and developing the photo-resist layer to form a photo-resist pattern;
(d) etching the substrate; and
(e) removing the photo-resist pattern to thereby provide the stamper.

2. The method for fabricating a stamper as recited in claim 1, wherein the substrate is a polished nickel sheet.

3. The method for fabricating a stamper as recited in claim 1, wherein the substrate is a polished steel sheet.

4. The method for fabricating a stamper as recited in claim 1, wherein the photo-resist layer is spin-coated on the substrate.

5. The method for fabricating a stamper as recited in claim 1, wherein the photo-resist layer is spray-coated on the substrate.

6. The method for fabricating a stamper as recited in claim 1, wherein the photo-resist layer is an organic, positive photo-resist.

7. The method for fabricating a stamper as recited in claim 1, wherein the photo-resist layer is an organic, negative photo-resist.

8. The method for fabricating a stamper as recited in claim 1, wherein in step (d), a dry etching method is used.

9. The method for fabricating a stamper as recited in claim 8, wherein in step (d), the dry etching method is reactive ion etching.

10. The method for fabricating a stamper as recited in claim 1, wherein in step (d), a wet etching method is used.

11. A method for fabricating a stamper, comprising:
providing a substrate for said stamper;
coating a light-sensitive layer on said substrate;
exposing and developing said light-sensitive layer to form a pattern on said substrate;
etching said substrate to form a complementary pattern according to said pattern; and
removing said pattern from said substrate.

12. The method as recited in claim 11, wherein reactive ion etching is used in said etching step.

13. A stamper comprising:
a substrate; and
a pattern etched from a surface of said substrate according to a complementary pattern, consisting of light-sensitive material, temporarily formed on said surface of said substrate.

14. The stamper as recited in claim 13, wherein said pattern is etched by reactive ion etching.
